(19) United States
(12) Patent Application Publication
(10) Pub. No.: US 2019/0061369 A1
(43) Pub. Date: Feb. 28, 2019

(54) Printing device and printing method

(71) Applicant: MIMAKI ENGINEERING CO., LTD., Nagano (JP)

(72) Inventor: Masaru Ohnishi, Nagano (JP)

(73) Assignee: MIMAKI ENGINEERING CO., LTD., Nagano (JP)

(21) Appl. No.: 16/103,943

(22) Filed: Aug. 15, 2018

(30) Foreign Application Priority Data
Aug. 18, 2017 (JP) 2017-157986

(51) Int. Cl. B41J 2/21; B41J 2/15

(52) U.S. Cl. CPC B41J 2/2135; B41J 2/15

(57) ABSTRACT

A printing device includes a head unit and a scanning driving unit, in which the head unit includes a same color head group, configured by a plurality of inkjet heads, a nozzle interval PL in the inkjet heads has a relationship of PL=k·Ph (k is a natural number greater than or equal to two) with respect to a dot interval Ph in the sub-scanning direction corresponding to a resolution of printing, and positions in the sub-scanning direction of a first head and an ith head is shifted by αi·PL+βi·Ph (αi is a natural number greater than or equal to one, βi is a natural number greater than or equal to one and smaller than or equal to k−1), the first head being a first inkjet head from one end side in the sub-scanning direction, and the ith head being the ith inkjet head from the one end side.

### CROSS REFERENCE TO RELATED APPLICATIONS

This application claims the priority benefit of Japanese Patent Application No. 2017-157986, filed on Aug. 18, 2017. The entirety of the above-mentioned patent application is hereby incorporated by reference herein and made a part of this specification.

### TECHNICAL FIELD

The present disclosure relates to a printing device and a printing method.

### DESCRIPTION OF THE BACKGROUND ART

Conventionally, an inkjet printer that carries out printing through an inkjet method has been widely used (see e.g., Japanese Unexamined Patent Publication Nos. 60-107975, 2008-155399). Furthermore, a serial type configuration of causing an inkjet head to carry out a main scanning operation (scan operation) has been widely used for the configuration of the inkjet printer.

Patent Literature 1: Japanese Unexamined Patent Publication Nos. 60-107975. Patent Literature 2: Japanese Unexamined Patent Publication Nos. 2008-155399.

### SUMMARY

When carrying out printing with the serial type inkjet printer having the conventional configuration, a streaky spot called banding may occur. In this case, banding is a streaky spot that occurs at a position corresponding to an end of the inkjet head and in units of print width when a difference arises in the manner the droplet of the ink landed on a medium (media) spreads between the end of the inkjet head and the vicinity of the end of the print width (width of a range of ejecting the ink in one main scanning operation) and other portions. More specifically, for example, in an interior region other than the vicinity of the end of the inkjet head, a print rate usually becomes high, and thus the dots of the ink tend to easily couple with each other. On the other hand, at the end of the inkjet head or the vicinity of the end of the print width, a difference easily arises with the other portions in a manner of spreading by the coupling of the dots of the ink, the contacting angle of the ink with respect to the medium, and the like when brought into contact with a non-printing region where the ink is not ejected and a region where the print rate becomes small in the relevant main scanning operation. As a result, the banding easily occurs. Furthermore, the banding particularly stands out when carrying out printing at fewer pass number of about smaller than or equal to one to four passes.

Various measures for alleviating the influence of banding have been conventionally proposed. For example, conventionally, printing through a multi-pass method in which the pass number is increased has been widely carried out to alleviate the influence of banding. In this case, the multi-pass method is, for example, a method of carrying out a plurality of main scanning operations with respect to one position on a medium. Furthermore, the multi-pass method can also be considered as a method of, for example, carrying out printing by carrying out printing in a plurality of main scanning operations rather than carrying out printing in only one main scanning operation with respect to a region of a width of the inkjet head (width in a sub-scanning direction).

When carrying out printing through the multi-pass method of a great number of pass number as above, the dot (print dot) of the ink formed in the same print pass is discretely landed as the pass number is increased. As a result, the spot and the like by the influence of the print width are less likely to occur. In this case, however, the pass number usually needs to be set to a large number such as 16 passes, 32 passes, or the like to carry out high quality printing. In this case, the speed of printing (average print speed) lowers substantially inversely proportional to the pass number. Thus, when carrying out printing through the conventional multi-pass method, it is difficult to simultaneously realize higher speed and higher quality of printing.

As a method of alleviating banding, for example, using a method (boundary position functional moving method) of moving a boundary position of a print pass according to a predetermined function is also considered. However, in this case as well, the main scanning operation needs to be carried out redundantly with respect to a portion of a width (functional moving width) of moving according to the function at the boundary, and thus the speed of printing lowers by such amount. In this case as well, it is usually necessary to simultaneously use the multi-pass method to sufficiently reduce the streaky spot, and the like. In this case, the speed of printing further lowers according to the pass number.

Furthermore, as a method of alleviating the banding, a method (boundary exclusive print method) of exclusively printing the boundary portion of the print pass in two successive main scanning operations, and the like are also known. As described in Japanese Unexamined Patent Publication No. 60-107975, for example, this method is a method of carrying out printing by exclusively mixing pass A and pass B to blur the boundary of the pass A and the pass B, which are the two successive print passes when printing with the print pass set to two. In this case as well, however, the main scanning operation needs to be carried out redundantly with respect to a region (portion of exclusive print width at the boundary) of exclusively carrying out printing in two print passes, and thus the speed of printing lowers by such amount. In this case as well, it is usually necessary to simultaneously use the multi-pass method to sufficiently reduce the streaky spot, and the like. In this case, the speed of printing further lowers according to the pass number.

As a method of alleviating the banding, jaggy method described in Japanese Unexamined Patent Publication No. 2008-155399, and the like, for example, are also known. In this case, the jaggy method is a method of preventing the boundary from visually standing out by changing the vicinity of the boundary of the print pass to a jaggy form (jaggy) within a constant range. In this case as well, however, the main scanning operation needs to be carried out redundantly with respect to a portion (portion of jaggy scanning width) of changing the boundary to a jaggy form, and thus the speed of printing lowers by such amount. In this case as well, it is usually necessary to simultaneously use the multi-pass method to sufficiently reduce the streaky spot, and the like. In this case, the speed of printing further lowers according to the pass number.

Thus, a configuration that can more appropriately carry out printing is conventionally desired in the serial type inkjet printer. The present disclosure provides a printing device and a printing method capable of solving the problems described above.

An inventor of the present application conducted a thorough research on a method for more appropriately carrying out printing with a serial type inkjet printer. First, the inventor has considered carrying out high resolution printing with one print pass by using a plurality of inkjet heads for an ink of a same color. More specifically, in this case, the interval in the sub-scanning direction of the dots of the ink that can be formed in one main scanning operation can be made smaller than the nozzle interval PL by arranging the plurality of inkjet heads while shifting the positions in the sub-scanning direction by a unit smaller than the nozzle interval PL in the nozzle row in one inkjet head. Thus, for example, the resolution of printing that can be realized with one print pass can be appropriately enhanced.

In this case, however, for example, if the plurality of inkjet heads are merely arranged while being shifted by a distance smaller than the nozzle interval PL, the position of the end of each inkjet head concentrates within a narrow range in the sub-scanning direction. In this case, the influence of the end in each inkjet head overlaps, and the influence of banding may become large.

The inventor of the present application has thus considered, through further thorough research, arranging the plurality of inkjet heads for the ink of the same color while shifting by a distance corresponding to a sum of a distance of integral multiples of the nozzle interval PL and a distance smaller than the nozzle interval PL, rather than arranging the plurality of inkjet heads while shifting merely by a distance smaller than the nozzle interval PL. Furthermore, according to such configuration, it is found that the influence of the banding can be appropriately reduced, and a more appropriate printing can be carried out.

More specifically, even in such a configuration, the interval in the sub-scanning direction of the dots of the inks that can be formed in one main scanning operation can be made smaller than the nozzle interval PL. Thus, for example, the resolution of printing that can be realized with one print pass can be appropriately enhanced. Furthermore, in this case, the position of the end of each inkjet head is dispersed in the sub-scanning direction, so that the influence of the end in each inkjet head can be appropriately prevented from overlapping. Moreover, for example, the influence of the banding can be appropriately prevented from becoming large. Furthermore, in this case, the boundary (boundary of print pass) of the region formed with each main scanning operation can be prevented from standing out by arranging the plurality of inkjet heads while shifting the positions in the sub-scanning direction. Moreover, in this case, for example, as high quality printing can be carried out without carrying out the main scanning operation redundantly with lowered print rate, carrying out the operation in the multi-pass method with the increased pass number, and the like, the printing speed can be appropriately increased. Thus, according to such configuration, for example, the printing through the inkjet method can be more appropriately carried out.

Furthermore, through further thorough research, the inventor of the present application has found features necessary for obtaining such effects and contrived the present disclosure. In order to solve the problem described above, the present disclosure provides a printing device that carries out printing through an inkjet method with respect to a medium, the printing device including a head unit that ejects an ink to the medium; and scanning driving unit that causes the head unit to carry out a main scanning operation and a sub-scanning operation, the main scanning operation ejecting the ink while relatively moving with respect to the medium in a main scanning direction set in advance, and the sub-scanning operation relatively moving with respect to the medium in a sub-scanning direction orthogonal to the main scanning direction, in which the head unit includes a same color head group configured by a plurality of inkjet heads that eject an ink of a same color; each of the plurality of inkjet heads in the same color head group includes a nozzle row in which a plurality of nozzles are arranged in a predetermined nozzle row direction at a constant nozzle interval PL and arranged with positions in the sub-scanning direction shifted from each other; the nozzle interval PL has a relationship of PL=k·Ph (k is a natural number greater than or equal to two) with respect to a dot interval Ph in the sub-scanning direction corresponding to a resolution of printing carried out with respect to the medium, the same color head group configured by k or more inkjet heads; and positions in the sub-scanning direction of a first head and an ith (i is a natural number greater than or equal to two and smaller than or equal to k) head are shifted by αi·PL+βi·Ph (αi is a natural number greater than or equal to one, βi is a natural number greater than or equal to one and smaller than or equal to k−1), the first head being the inkjet head, the position of which in the sub-scanning direction is first from one end side in the sub-scanning direction of the plurality of inkjet heads in the same color head group, and the ith head being the inkjet head, the position of which in the sub-scanning direction is ith from the one end side.

According to such configuration, for example, the interval in the sub-scanning direction of the dots of the inks that can be formed in one main scanning operation can be made smaller than the nozzle interval PL. Thus, for example, the resolution of printing that can be realized with one main scanning operation (print pass) can be appropriately enhanced. Furthermore, in this case, the boundary of the region formed with each scanning operation can be prevented from standing out by arranging the inkjet heads in the same color head group while shifting the positions in the sub-scanning direction. Thus, according to such configuration, for example, high quality printing can be appropriately carried out at high speed. Furthermore, for example, the printing through the inkjet method can be more appropriately carried out.

Furthermore, in such configuration, the scanning driving unit preferably causes the head unit to carry out the main scanning operation and the sub-scanning operation so that each of the inkjet heads in the same color head group carries out only one main scanning operation with respect to each position of the medium. According to such configuration, for example, printing speed can be more appropriately increased. Furthermore, in such configuration, the head unit preferably includes a plurality of same color head groups each ejecting an ink of a color different from each other. According to such configuration, for example, color printing using inks of a plurality of colors can be appropriately carried out.

Furthermore, with respect to the arrangement of the plurality of inkjet heads in the same color head group, for example, a position in the sub-scanning direction of a jth (j is a natural number greater than or equal to two and smaller than or equal to k, and different from i) head being the inkjet head, the position of which in the sub-scanning direction is jth from the one end side in the sub-scanning direction of the plurality of inkjet heads in the same color head group, is shifted by αj·PL+βj·Ph (αj is a natural number greater than or equal to one, βj is a natural number greater than or equal to one and smaller than or equal to k−1) from the first head. In this case, βj is preferably a natural number different from βi. Similarly, αj is preferably a natural number different from αi. According to such configuration, for example, the plurality of inkjet heads in the same color head group can be more appropriately arranged. More specifically, in this case, αi, αj, βi, βj can be considered to be set to satisfy αi=(i−1)·A (A is a natural number greater than or equal to one), αj=(j−1)·A, and βi=i−1, βj=j−1. According to such configuration, for example, the plurality of inkjet heads can be arranged regularly and appropriately.

Moreover, the arrangement of the plurality of inkjet heads in the same color head group can also be considered focusing on the arrangement of the nozzles in the same color nozzle row in the same color head group. In this case, the same color nozzle row is, for example, the arrangement of the plurality of nozzles (all nozzles) included in each of all the inkjet heads in the same color head group. Furthermore, the same color nozzle row can be considered as a virtual nozzle row focusing on the positions in the sub-scanning direction of all the nozzles in the same color head group. Moreover, in this case, the one end side region, the other end side region, and the central region in the same color nozzle row are preferably distinguished, and the nozzle density is preferably set in the respective regions. In this case, the one end side region is a region on one end side in the sub-scanning direction. The other end side region is a region on the other end side in the sub-scanning direction. The central region is a region between the one end side region and the other end side region. Furthermore, the nozzle density is, for example, the density at which the nozzles are arranged in the sub-scanning direction.

Furthermore, in this case, the nozzle density in the one end side region and the other end side region can be considered as being smaller than the resolution corresponding density. The resolution corresponding density is, for example, the nozzle density of when the interval in the sub-scanning direction is equal to the dot interval Ph. Furthermore, in this case, the nozzle density in the central region is preferably equal to the resolution corresponding density. Moreover, in this case, in the sub-scanning operation carried out between two successive main scanning operations, for example, the scanning driving section relatively moves the plurality of inkjet heads in the same color head group in the sub-scanning direction by a feeding amount (feeding width) equal to a length in the sub-scanning direction of a range combining the one end side region and the central region with respect to the medium. According to such configuration, for example, the operation of printing using the same color head group including the plurality of inkjet heads, the positions of which in the sub-scanning direction are shifted, can be appropriately carried out.

Furthermore, in this case, a relationship of a position of a nozzle in the other end side region and a position of a nozzle in the one end side region is considered as a relationship (complementary set function) in which the positions of the nozzles ejecting the ink in each region become complementary at the time of the main scanning operation. More specifically, in this case, for example, with respect to the region where the nozzle, which is included in one of the one end side region or the other end side region in the same color nozzle row, ejects the ink in any one of the main scanning operation, the ink is ejected by the nozzle included in the other one of the one end side region or the other end side region in the next one of the main scanning operation. In this case, a relationship of the position of the nozzle in the one end side region and the position of the nozzle in the other end side region can be considered to be in a complementary relationship. In this case, the complementary relationship is for example, such that with respect to the position where the ink cannot be ejected with the nozzle included in one of the one end side region or the other end side region in any one of the main scanning operation as the nozzle density is smaller than the resolution corresponding density, the nozzle included in the other one of the one end side region or the other end side region can eject the ink in the next one of the main scanning operation. According to such configuration, for example, the operation of printing using the same color head group including the plurality of inkjet heads, the positions of which in the sub-scanning direction are shifted, can be appropriately carried out. Furthermore, the complementary relationship can also be considered as a relationship in which when the one end side region and the other end side region are overlapped with the positions in the sub-scanning direction aligned, the nozzle density in the arrangement of the nozzles, where the nozzles of both regions are combined, becomes equal to the resolution corresponding density.

Furthermore, in such configuration, a dot of an ink can be formed at high density on the medium in each main scanning operation by using the same color head group including the plurality of inkjet heads which positions in the sub-scanning direction are shifted. Thus, an ink in which the viscosity of the ink is sufficiently enhanced immediately after landing on the medium is preferably used for the ink. More specifically, for example, an ink that generates heat by irradiation of an energy line such as an ultraviolet light can be suitably used for such ink. In this case, the ink is directly heated by the irradiation of the energy line, so that the solvent in the ink is evaporated in a short time and the viscosity of the ink can be appropriately enhanced up to a viscosity at which smearing does not occur. Furthermore, in this case, for example, the head unit further includes an energy line irradiating unit that irradiates an ink attached to the medium with an energy line. The energy line irradiating unit irradiates the ink with the energy line to volatilize and remove at least one part of the solvent in the ink. In this case, for example, the ink is preferably heated so that the temperature of the ink becomes higher than the medium. Furthermore, in this case, for example, the ink may be heated up to a temperature the solvent of the ink boils. According to such configuration, for example, the viscosity of the ink can be appropriately enhanced in a short time.

Furthermore, using an ink that contains a solvent having a lower boiling point than water, and the like can be considered for the ink that can volatilize and remove the solvent in a short time. In this case, for example, an ink using alcohol for the solvent, and the like can be considered. Furthermore, consideration can be made to using an ultraviolet curable ink that is cured by the irradiation of the ultraviolet light for the ink. In this case, the head unit further includes, for example, an ultraviolet light source that irradiates an ink attached to the medium with an ultraviolet light. Even when configured in such a manner, for example, the smearing can be appropriately prevented from occurring by irradiating the ultraviolet light immediately after the landing of the ink.

Consideration can be made to using a printing method having features similar to the above, and the like for the configuration of the present disclosure. In this case as well, for example, effects similar to the above can be obtained.

According to the present disclosure, for example, the printing through the inkjet method can be more appropriately carried out.

### BRIEF DESCRIPTION OF THE DRAWINGS

FIG. 1 is a view showing one example of a configuration of a main part of a printing device 10 according to one embodiment of the present disclosure;

FIG. 2A and FIG. 2B are views describing a detailed configuration of combined heads 102c to 102k; FIG. 2A shows one example of a configuration of an inkjet head used in a combined head 102; FIG. 2B shows one example of an arrangement of a plurality of inkjet heads 300 of one combined head 102;

FIG. 3A and FIG. 3B are views describing in further detail positions of dots of an ink that can be formed with one combined head 102 in one main scanning operation; FIG. 3A is a view describing in further detail a position of a nozzle 304 in inkjet heads 300a to 30d in the combined head 102; FIG. 3B is a view describing in further detail a same color nozzle row 306 in the combined head 102;

FIG. 4 is a view describing in further detail an operation of printing carried out in the present example;

FIG. 5A to FIG. 5C are views describing an alternative embodiment of a configuration of the combined head 102; FIG. 5A to FIG. 5C are views describing various features of the present alternative embodiment;

FIG. 6 is a view describing an alternative embodiment of the configuration of the combined head 102;

FIG. 7A and FIG. 7B are views describing a further alternative embodiment of the configuration of the combined head 102; FIG. 7A shows an example of an arrangement of a plurality of inkjet heads 300a to 300d2 in the combined head 102; FIG. 7B is a view describing a position of a nozzle in the combined head 102 of the present alternative embodiment;

FIG. 8A and FIG. 8B are views describing in further detail the features of the present alternative embodiment; FIG. 8A and FIG. 8B show features of the present alternative embodiment corresponding to one part of a matter shown in FIG. 3A and FIG. 3B, and the like;

FIG. 9 is a view showing features of the present alternative embodiment corresponding to one part of the matter shown in FIG. 4; and

FIG. 10 is a view showing a further alternative embodiment of the configuration of the combined head 102.

### DETAILED DESCRIPTION OF EMBODIMENTS

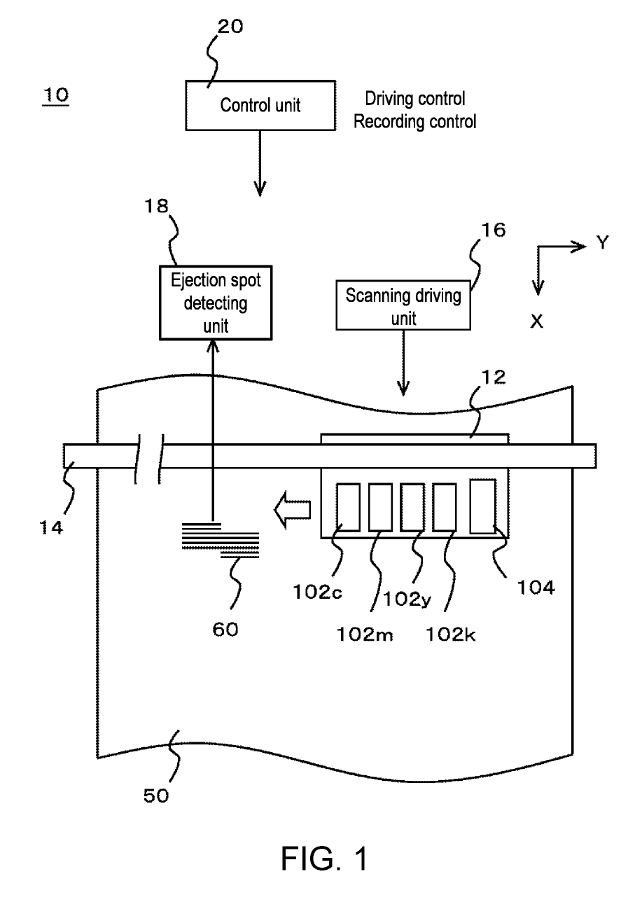

Hereinafter, an embodiment according to the present disclosure will be described with reference to the drawings. FIG. 1 is a view showing one example of a configuration of a main part of a printing device 10 according to one embodiment of the present disclosure, and shows one part of a configuration of the printing device 10 seen from a top side, and one part of a functional configuration of the printing device 10. In the present example, the printing device 10 is an inkjet printer that carries out printing through the inkjet method with respect to a medium (media) 50 to be printed, and includes a head unit 12, a guide rail 14, a scanning driving unit 16, an ejection spot detecting unit 18, and a control unit 20. Excluding the points described below, the printing device 10 may have features same as or similar to the known inkjet printer. For example, the printing device 10 may further include various types of configurations similar to the known inkjet printer other than the illustrated configuration.

The head unit 12 is a portion that ejects ink with respect to the medium 50, and ejects the ink onto the medium 50 by carrying out a main scanning operation. In this case, the main scanning operation is an operation of ejecting the ink while relatively moving with respect to the medium 50 in a main scanning direction set in advance. In the present example, the head unit 12 ejects inks of a plurality of colors different from each other while moving in the main scanning direction parallel to a Y direction (Y axis direction) in the figure at the time of the main scanning operation. Furthermore, in this case, the ink of each color of cyan (C), magenta (M), yellow (Y), and black (K) is ejected for the inks of the plurality of colors different from each other. The configuration of the head unit 12 will be described in further detail later.

The guide rail 14 is a rail member that guides the movement of the head unit 12 at the time of the main scanning operation. The scanning driving unit 16 is a driving unit that causes the head unit 12 to carry out the main scanning operation and a sub-scanning operation. In this case, the sub-scanning operation is an operation of relatively moving with respect to the medium 50 in a sub-scanning direction orthogonal to the main scanning direction. Furthermore, in the present example, the scanning driving unit 16 relatively moves the head unit 12 in the sub-scanning direction with respect to the medium 50 by transporting the medium 50 in a transporting direction parallel to an X direction (X-axis direction) in the figure. In an alternative embodiment of the configuration of the printing device 10, the scanning driving unit 16 may cause the head unit 12 to carry out the sub-scanning operation by moving a Y-axis moving mechanism including the head unit 12, the guide rail 14, and the like. In this case, the Y-axis moving mechanism is a moving mechanism for causing the head unit 12 to carry out the main scanning operation.

The ejection spot detecting unit 18 is a sensor unit (ejection spot detecting means) used when adjusting an ejection property of the ink by the head unit 12. In this case, the adjustment of the ejection property is, for example, the adjustment with respect to the ejection property of each nozzle that ejects ink in the head unit 12. Furthermore, at the time of the adjustment of the ejection property, the ejection spot detecting unit 18 detects presence or absence of a spot (ejection spot) formed by the shift in the ejection property by, for example, reading an ejection spot detection pattern 60 drawn on the medium 50 by the head unit 12. Moreover, the ejection spot detection pattern 60 transmits the detection result to the control unit 20 to cause the control unit 20 to carry out a correction (nozzle spot correction) of the necessary ejection property, and the like. The adjustment of the ejection property carried out in the present example will be described in further detail later.

The control unit 20 is a controller that controls the operation of each unit of the printing device 10. Furthermore, in the present example, the control unit 20 carries out, for example, control such as recording control, driving control, and the like. In this case, the driving control is, for example, a control of an operation of moving the head unit 12 at the time of the main scanning operation and an operation of transporting the medium 50 at the time of the sub-scanning operation. Furthermore, the recording control is, for example, a control of causing each nozzle of the head unit 12 to eject an ink according to an image to be printed. Moreover, the control unit 20 carries out a control of the correction of the nozzle spot, the exclusive two pass scanning, and the like as at least one part of the recording control. In this case, the control of the correction of the nozzle spot is, for example, a control of suppressing the spot formed by the shift in the ejection property of the nozzle by adjusting the ejection property of each nozzle. The control of the exclusive two pass scanning is a control of the operation of printing in the present example to be described in detail later.

When an abnormal nozzle (e.g., non-ejecting nozzle, etc.) that cannot be handled with the correction of the ejection property exists, a control of a nozzle recovery for carrying out the printing without using the abnormal nozzle, and the like may be further carried out as the recording control. In this case, consideration is made to reduce an effective print width in the head unit 12 and carry out an alternative process of the nozzle, and the like. Furthermore, when the abnormal nozzle exists, consideration is also made to replace the configuration including the abnormal nozzle, and the like. In this case, for example, consideration is made to carry out the replacement in units of unit configuring one part of the head unit 12. Furthermore, in this case, the unit is, for example, a combined head, an inkjet head, or the like described below. Moreover, in order to carry out such controls, the control unit 20 may include, for example, a nozzle spot correction circuit, an exclusive two pass scanning control circuit, a nozzle recovery circuit, and the like.

Next, the configuration of the head unit 12 will be described in further detail. In the present example, the head unit 12 includes a plurality of combined heads and an ultraviolet light source 104. As shown in the figure, the plurality of combined heads include a combined head 102c, a combined head 102m, a combined head 102y, and a combined head 102k (hereinafter referred to as combined heads 102c to 102k). Each of the combined heads 102c to 102k is an example of a same color head group, and is configured by a plurality of inkjet heads that eject the ink of the same color set in advance for every combined head. More specifically, the combined head 102c is configured by a plurality of inkjet heads that eject an ink of cyan (C) color. The combined head 102m is configured by a plurality of inkjet heads that eject an ink of magenta (M) color. The combined head 102y is configured by a plurality of inkjet heads that eject an ink of yellow (Y) color. The combined head 102k is configured by a plurality of inkjet heads that eject an ink of black (K) color. The arrangement, and the like of the plurality of inkjet heads configuring each of the combined heads 102c to 102k will be described in further detail later. Furthermore, the combined heads 102c to 102k are, for example, arranged side by side in the main scanning direction with the respective positions in the sub-scanning direction aligned, as shown in the figure.

A known inkjet head can be suitably used for the inkjet head of the combined heads 102c to 102k. More specifically, a known inkjet head, and the like that eject the ink through a piezo method, for example, can be suitably used for the inkjet head. Furthermore, for example, an inkjet head of a thermal jet method may be used for the inkjet head. Moreover, the ink of each color of CMYK is an example of a color ink (process color ink) for full color printing.

In the present example, each of the combined heads 102c to 102k uses an evaporative drying type ink that generates heat by the irradiation of the ultraviolet light for the ink of each color of CMYK. In this case, the ultraviolet light is an example of an energy line used to cause the ink to generate heat. Furthermore, when referring to the ink generating heat by the irradiation of the ultraviolet light, this means, for example, that the ink itself generates heat as the component in the ink absorbs the irradiated ultraviolet light. When using such ink, for example, the ink is directly heated by the irradiation of the ultraviolet light, so that the solvent in the ink is evaporated in a short time and the viscosity of the ink can be appropriately enhanced up to a viscosity at which smearing does not occur. Thus, the viscosity of the ink can be appropriately and sufficiently enhanced before the smearing occurs by, for example, irradiating the ink with the ultraviolet light immediately after landing on the medium 50.

Furthermore, such ink can be considered as, for example, an instant drying type ink that includes a coloring material and a solvent, and that generates heat by irradiation of the energy line (ultraviolet light). In this case, the instant drying type ink is an ink that sufficiently dries in a short time by the irradiation of the energy line such as ultraviolet light, and the like. Furthermore, when referring to sufficiently drying, this means that, for example, the viscosity of the ink enhances up to the viscosity at which the smearing does not occur on at least the medium 50. Furthermore, when referring to the smearing not occurring on the medium 50, for example, this means that the smearing being a problem substantially does not occur according to the precision required for the printing. Moreover, consideration is made to using, for example, an ink containing an energy line absorbing agent that absorbs the energy line for such ink. For example, when using the ultraviolet light as the energy line as in the present example, consideration is made to using the ink containing the ultraviolet light absorbing agent. Furthermore, the ink can be caused to generate heat without intentionally adding the energy line absorbing agent depending on the color, the composition, and the like of the ink. More specifically, for example, when using the ink containing the coloring material that sufficiently absorbs the energy line irradiated on the ink, consideration is also made to cause the ink to generate heat by having the coloring material absorb the energy line.

The ultraviolet light source 104 is an ultraviolet light source that irradiates the ink attached to the medium 50 with the ultraviolet light. A light source using an UVLED (UVLED irradiator), for example, can be suitably used for the ultraviolet light source 104. In the present example, the ultraviolet light source 104 is an example of an energy line irradiating unit, and irradiates the ink on the medium 50 with the ultraviolet light to volatilize and remove at least one part of the solvent in the ink. The viscosity of the ink is thereby enhanced up to the viscosity at which the smearing does not occur on at least the medium 50.

When configured in such a manner, for example, instead of the ink being indirectly heated by heating the medium 50, the ink can be directly heated. In this case, for example, the ink is preferably heated so that the temperature of the ink becomes higher than that of the medium 50. According to such configuration, for example, the viscosity of the ink can be appropriately enhanced in a short time. Furthermore, in this case, for example, the ink may be heated up to a temperature the solvent of the ink is boiled on the medium 50. When referring to the ink being boiled on the medium 50, for example, this means that the solvent in the ink is boiled. According to such configuration, for example, the viscosity of the ink on the medium 50 can be more appropriately enhanced in a short time. Furthermore, in this case, for example, the ink can be efficiently heated, and thus for example, the power consumption necessary for drying the ink can also be reduced, and the like.

In the present example, for example, the ultraviolet light source 104 is arranged side by side with the combined heads 102c to 102k so that the position in the sub-scanning direction overlaps the combined heads 102c to 102k, as shown in the figure. According to such configuration, for example, the viscosity of the ink ejected by the combined heads 102c to 102k during each main scanning operation can be appropriately enhanced. Furthermore, in this case, the ultraviolet light source 104 is arranged so as to be, for example, on the back side of the combined heads 102c to 102k at the time of the main scanning operation. Thus, when carrying out the main scanning operation so that the head unit 12 moves in the arrow direction (moving direction at time of head recording) shown in the figure, the ultraviolet light source 104 is arranged so as to be on the back side in the direction of the arrow with respect to the combined heads 102c to 102k, as shown in the figure. Furthermore, in the printing device 10, consideration is also made to, for example, carrying out the two-way main scanning operation in the directions of one side and the other side in the main scanning direction. In this case, the ultraviolet light source 104 is preferably arranged on one side and the other side in the main scanning direction with respect to the combined heads 102c to 102k. Furthermore, in this case, it is considered to irradiate the medium 50 with the ultraviolet light from the ultraviolet light source 104 on the back side of the combined heads 102c to 102k in each main scanning operation.

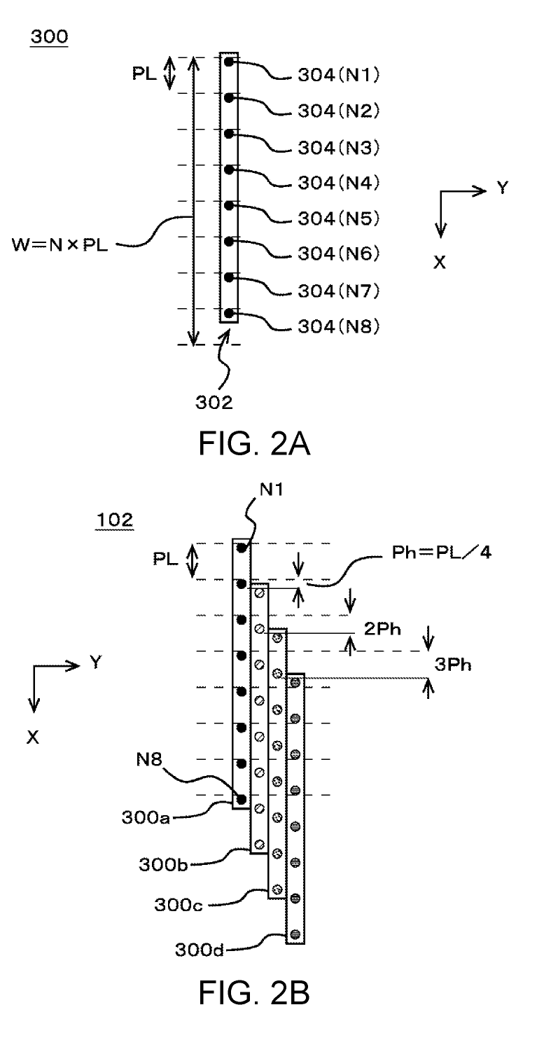

The arrangement, and the like of the plurality of inkjet heads configuring each of the combined heads 102c to 102k will be described now in further detail later. FIG. 2A and FIG. 2B are views describing a detailed configuration of each of the combined heads 102c to 102k. Excluding the points described above and below, in the present example, each of the combined heads 102c to 102k has the same or similar features. More specifically, for example, excluding the color of the ink to use, the position in the head unit 12, and the like, each of the combined heads 102c to 102k has the same or similar features. Furthermore, for example, each of the combined heads 102c to 102k has the same or similar features in terms of the configuration, the arrangement, and the like of the plurality of inkjet heads configuring each of the combined heads 102c to 102k. Hereinafter, the feature common to the combined heads 102c to 102k will be simply described as the feature of the combined head 102 for the sake of convenience of illustration and description.

FIG. 2A is a view showing one example of the configuration of the inkjet head used in the combined head 102, and shows the configuration of an inkjet head 300 representatively showing the plurality of inkjet heads in the combined head 102 in a simplified manner. The inkjet head 300 includes a nozzle row 302 in which a plurality of nozzles 304 are arranged in a predetermined nozzle row direction. Furthermore, in the present example, the nozzle row direction is a direction parallel to the sub-scanning direction, as shown in the figure. In this case, when the nozzle row direction is parallel to the sub-scanning direction, this means that the nozzle row direction becomes parallel to the sub-scanning direction in a state that the inkjet head 300 is attached to the printing device 10 (see FIG. 1). The plurality of nozzles 304 are arranged at a constant nozzle interval PL in the nozzle row 302.

In FIG. 2A and FIG. 2B, one example of the configuration of the inkjet head 300 is illustrated with only eight nozzles 304, N1 to N8 in the figure, in one nozzle row 302 for the simplification of the illustration. However, in the actual printing device 10, the inkjet head 300 including more nozzles 304 is preferably used. In this case, the number of nozzles 304 of one inkjet head 300 is preferably about a few hundred or more (e.g., 100 or more, preferably 200 or more). Furthermore, in the present example, a product (N×PL) of the number N of nozzles in one inkjet head 300 and the nozzle interval PL is considered as a width W of one inkjet head 300 in the sub-scanning direction. Furthermore, in this case, an effective width of the nozzle in the inkjet head 300 can be considered as (N−1)×PL. In this case, the effective width of the nozzle is the length of the nozzle row 302 in the sub-scanning direction.

Furthermore, in the combined head 102 of the present example, a plurality of inkjet heads 300 are arranged with the positions in the sub-scanning direction shifted. FIG. 2B is a view showing one example of an arrangement of the plurality of inkjet heads 300 of one combined head 102, and shows one example of the arrangement of four inkjet heads 300, inkjet heads 300a to 300d in the figure, when the number of inkjet heads 300 in one combined head 102 is four. Furthermore, in the present example, a shift amount in the sub-scanning direction for the plurality of inkjet heads 300a to 300d configuring one combined head 102 is set to a distance other than integral multiples of the nozzle interval PL to enhance the resolution at which the printing can be carried out by the combined head 102 in one main scanning operation. More specifically, in the case shown in the figure, the plurality of inkjet heads 300a to 300d are arranged side by side in the main scanning direction while sequentially shifting the position in the sub-scanning direction by 1.25 times the nozzle interval PL (1.25 PL).

In this case, assuming Ph=¼ PL and excluding the nozzle 304 in the vicinity of the end in the sub-scanning direction, the position of the nozzle 304 in the inkjet head 300a and the position of the nozzle 304 in the inkjet head 300b are shifted by Ph in the sub-scanning direction. Furthermore, the position of the nozzle 304 in the inkjet head 300a and the position of the nozzle 304 in the inkjet head 300c are shifted by 2 Ph in the sub-scanning direction. Moreover, the position of the nozzle 304 in the inkjet head 300a and the position of the nozzle 304 in the inkjet head 300d are shifted by 3 Ph in the sub-scanning direction. Thus, excluding the vicinity of the end in the sub-scanning direction and focusing on the position in the sub-scanning direction of each nozzle 304 of the inkjet heads 300a to 300d (positions of all the nozzles in the combined head 102), a minimum distance between the nozzles 304 in the sub-scanning direction becomes equal to 0.25 times (¼) the nozzle interval PL.

Furthermore, in this case, the combined head 102 can eject the ink using all the nozzles of the inkjet heads 300a to 300d at a maximum in one main scanning operation. In this case, the minimum interval in the sub-scanning direction of the dots of the ink that can be formed in one main scanning operation becomes equal to Ph. Thus, the distance Ph is hereinafter referred to as a dot interval Ph. Furthermore, in this case, the dot interval Ph becomes equal to, for example, the dot interval in the sub-scanning direction corresponding to the resolution of printing carried out on the medium (dot interval Ph corresponding to the resolution of printing in the sub-scanning direction).

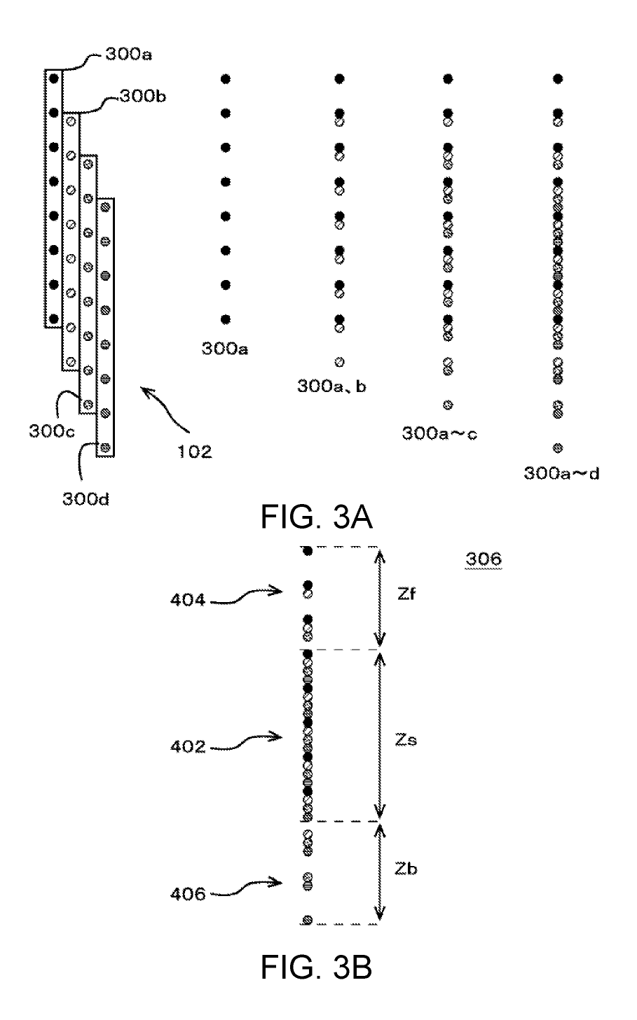

FIG. 3A and FIG. 3B are views describing in further detail the positions of dots of an ink that can be formed with one combined head 102 in one main scanning operation. FIG. 3A is a view describing in further detail a position of a nozzle 304 in inkjet heads 300a to 300d in the combined head 102. In FIG. 3A, a figure on the most left side is a view showing the arrangement of the plurality of inkjet heads 300a to 300d in one combined head 102, and shows the inkjet heads 300a to 300d arranged in the same arrangement as the combined head 102 shown in FIG. 2B. The second and subsequent figures from the left show the position of each nozzle in the sub-scanning direction focusing on the nozzles included in one to four inkjet heads in the combined head 102. Furthermore, the positions of each of such nozzles can be considered as, for example, a print pattern for one line extending in the sub-scanning direction. More specifically, the second figure from the left shows the positions of each nozzle in the sub-scanning direction for one inkjet head 300a. The third figure from the left shows the positions of each nozzle in the sub-scanning direction for two inkjet heads 300a, 300b. The fourth figure from the left shows the positions of each nozzle in the sub-scanning direction for three inkjet heads 300a to 300c. The fifth figure from the left shows the positions of each nozzle in the sub-scanning direction for four inkjet heads 300a to 300d. Such figures can also be considered as figures corresponding to the result of carrying out printing in an overlapping manner with one to four nozzle rows of the inkjet heads 300a to 300d, and the like.

As apparent from the figures, in the present example, the combined head (set high resolution head) having a high nozzle density in the sub-scanning direction than one inkjet head is realized by using the combined head 102 including the plurality of inkjet heads 300a to 300d. Furthermore, in this case, a virtual nozzle row can be considered focusing on the position of each nozzle in the sub-scanning direction for all the nozzles in the one combined head 102. Such virtual nozzle row is referred to as a same color nozzle row below. The same color nozzle row can also be considered as the arrangement of the plurality of nozzles included in each of all the inkjet heads in the combined head 102, and the like. Furthermore, in this case, the interval of the nozzles in each of the inkjet heads 300a to 300d can be said large compared to the high resolution realized in the combined head 102. Thus, each of the inkjet heads 300a to 300d can also be considered as a low resolution head in which the resolution of the nozzle is low compared to the same color nozzle row 306, and the like.

FIG. 3B is a view describing in further detail a same color nozzle row 306 in the combined head 102. In this case, the same color nozzle row 306 is a virtual nozzle row in which a plurality of nozzles are arranged similar to the fifth figure from the left in FIG. 3A. As described above, in the present example, the plurality of inkjet heads 300a to 300d have the positions in the sub-scanning direction sequentially shifted by 1.25 times the nozzle interval PL (1.25 PL). In this case, the position of the nozzle in the same color nozzle row 306 becomes dense at a central region 402, which is a region in the vicinity of the center, and scarce at one end side region 404, which is a region on one end side, and an other end side region 406, which is a region on the other end side, with respect to the central region 402, as shown in the figure. In this case, when referring to the position of the nozzle being scarce, this means that the proportion (Duty) of the position, where the dot of the ink can be formed when printing at the relevant region, becomes low. The proportion of the position where the dot of the ink can be formed is, for example, the proportion with respect to all the dot positions set according to the resolution of printing.

More specifically, in the present example, the central region 402 is a region corresponding to a range where all the inkjet heads 300a to 300d in the combined head 102 are overlapped in the sub-scanning direction, and is sandwiched by the one end side region 404 and the other end side region 406 in the sub-scanning direction. Furthermore, in the central region 402, the nozzles are arranged so that the interval in the sub-scanning direction becomes equal to the dot interval Ph. Thus, it can be said that the ink can be ejected to all the ejection positions with one main scanning operation for the central region 402. In this case, when the ink can be ejected to all the ejection positions with one main scanning operation, for example, this means that entirely solid printing can be carried out with one main scanning operation. Furthermore, in this case, the nozzle density in the central region 402 can be considered as being equal to a resolution corresponding density. The resolution corresponding density is, for example, the nozzle density of when the interval in the main scanning direction is equal to the dot interval Ph. Furthermore, the nozzle density is, for example, the density at which the nozzles are arranged in the sub-scanning direction.

The one end side region 404 and the other end side region 406 are regions other than the central region 402 in the same color nozzle row 306, and are regions where the nozzles are more scarcely arranged than the central region 402 as the interval of the nozzles becomes greater than the dot Ph at least at one part. Furthermore, in this case, the nozzle density in the one end side region 404 and the other end side region 406 can be considered as being smaller than the resolution corresponding density.

In this case, the position of the nozzle in the one end side region 404 and the position of the nozzle in the other end side region 406 are determined according to the shifting manner of the positions in the sub-scanning direction of the plurality of inkjet heads 300a to 300d. As a result, such positions are in a relationship (complementary set function) in which the positions of the nozzles ejecting the ink in each region become complementary at the time of the main scanning operation. In this case, the complementary relationship is for example, such that with respect to the position where the ink cannot be ejected with the nozzle included in one of the one end side region 404 and the other end side region 406 in one main scanning operation (any one of the main scanning operation) as the nozzle density is smaller than the resolution corresponding density, the nozzle included in the other one of the one end side region 404 and the other end side region 406 can eject the ink in another one (e.g., next) of the main scanning operation. More specifically, in the present example, for example, with respect to the region where the nozzle included in the other end side region 406 ejected the ink in any one of the main scanning operation, the ink is ejected by the nozzle included in the one end side region 404 in the next one of the main scanning operation. The ink worth the resolution corresponding density is thus ejected in two main scanning operations of ejecting the ink by the one end side region 404 and the other end side region 406. Furthermore, the complementary relationship can also be considered as a relationship in which when the one end side region 404 and the other end side region 406 are overlapped with the positions in the sub-scanning direction aligned, the nozzle density in the arrangement of the nozzles, where the nozzles of both regions are combined, becomes equal to the resolution corresponding density. Furthermore, in this case, the combined head 102 can be considered as a high resolution head (complementary set high resolution head) in which both ends in the sub-scanning direction are in a complementary set relationship.

Furthermore, in this case, the widths (lengths in the sub-scanning direction) of the central region 402, the one end side region 404 and the other end side region 406 are determined according to the shifting manner of the positions in the sub-scanning direction of the plurality of inkjet heads 300a to 300d. Moreover, in FIG. 3B, the respective widths of the central region 402, the one end side region 404 and the other end side region 406 are illustrated as Zs, Zf, and Zb. In this case, a relationship Zb=Zf is satisfied. Furthermore, Zb and Zf are preferably smaller than or equal to ½ the width W of the inkjet head 300.

In the present example, the printing in the operation of one pass is carried out using such combined head 102. In this case, the printing in the operation of one pass means, for example, carrying out the printing so that the respective inkjet heads in the combined head 102 carries out only one main scanning operation with respect to each position of the medium. The operation of one pass can also be considered as an operation of, for example, carrying out printing while enabling all the nozzles in the inkjet head. In this case, enabling all the nozzles means, for example, allowing the ink to be ejected as necessary from all the nozzles without using a mask, and the like that selects only some nozzles.

Furthermore, in this case, the dots of all the necessary inks are formed in one main scanning operation with respect to a region on the medium 50 where the central region 402 of the same color nozzle row 306 passes. Furthermore, the dots of all the necessary inks are formed in two main scanning operations with the sub-scanning operation in between with respect to a region on the medium 50 where the one end side region 404 and the other end side region 406 of the same color nozzle row 306 pass. In this case, in one of the two main scanning operations, the ink is ejected with the nozzle included in either one of the one end side region 404 or the other end side region 406 with respect to each position of forming the dot of the ink. Thus, the operation of printing in the present example can be considered as, for example, the exclusive two pass scanning in which the exclusive two main scanning operations are carried out with respect to the region of one part. Furthermore, in this case, the combined head 102 can also be considered as, for example, a high resolution head (one pass high resolution serial head) in which the printing in one pass can be carried out. Moreover, the same color nozzle row 306 can be considered to have, for example, the nozzles arranged in the sub-scanning direction so that redundant scanning in the main scanning direction with the same nozzle is not carried out between different main scanning operations (between passes).

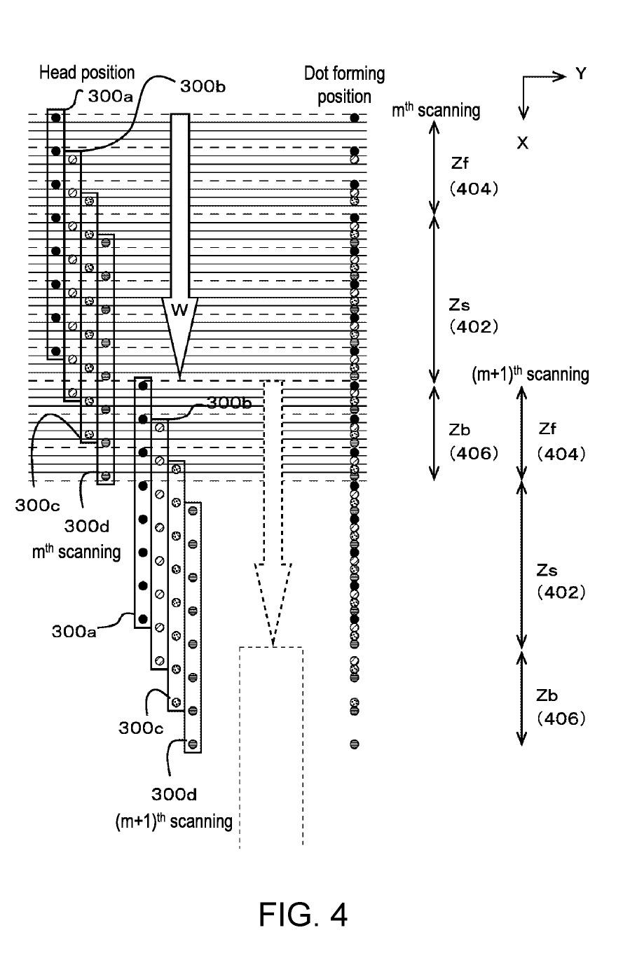

FIG. 4 is a view describing in further detail an operation (print scanning) of printing carried out in the present example, and shows one example of a relationship of a position (head position) in the sub-scanning direction of the plurality of inkjet heads 300a to 300d in the combined head and a position (dot forming position) in the sub-scanning direction of the dot of the ink to be formed for mth scanning and (m+1)th scanning, which are two successive main scanning operations, focusing on the combined head for one color. In this case, the mth scanning and the (m+1)th scanning are mth (m is a natural number greater than or equal to one) and (m+1)th main scanning operation to be carried out by the head unit 12 with the sub-scanning operation in between. Furthermore, the range indicated with an arrow on the right side of the figure is a range of the central region 402, the one end side region 404, and the other end side region 406 of the same color nozzle row 306 at the time of each main scanning operation.

As described above, in the present example, the printing with respect to the medium 50 is carried out by causing the head unit 12 (see FIG. 1) to carry out the main scanning operation and the sub-scanning operation by the scanning driving unit 16 (see FIG. 1). In this case, the scanning driving unit 16 transports the medium 50 by a distance equal to the width W of one inkjet head 300 in the sub-scanning direction, for example, in the sub-scanning operation carried out between two successive main scanning operations. The plurality of inkjet heads 300a to 300d are thereby relatively moved in the sub-scanning direction with respect to the medium 50. Furthermore, in the present example, the width W of the inkjet head 300 is equal to a length in the sub-scanning direction of a range combining the central region 402 and the one end side region 404 in the same color nozzle row. Thus, a feeding amount at the time of the sub-scanning operation can also be considered as, for example, a distance equal to the length in the sub-scanning direction of the range combining the central region 402 and the one end side region 404.

Furthermore, in this case, as can be seen from the range of the central region 402, the one end side region 404, and the other end side region 406 shown on the right side of the figure, the range where the other end side region 406 of the same color nozzle row 306 passes in the nth scanning becomes the same as the range where the one end side region 404 of the same color nozzle row 306 passes in the (m+1)th scanning. Thus, according to the present example, for example, the exclusive two pass scanning can be appropriately carried out using the one end side region 404 and the other end side region 406 in which the positions of the nozzles are complementary. Furthermore, after carrying out the (m+1)th scanning, the head unit 12 is caused to carry out the sub-scanning direction at the feeding amount same as the previous turn, and the head unit 12 is further caused to carry out the main scanning operation of the next turn. According to such configuration, for example, the head unit 12 can be caused to carry out the main scanning operation with respect to the entire region where the printing is to be carried out in the medium 50. Thus, for example, the operation of printing using the combined head including the plurality of inkjet heads 300a to 300d, the positions of which in the sub-scanning direction are shifted, can be appropriately carried out.

Furthermore, in this case, high speed printing can be appropriately carried out by carrying out the printing in the operation of one pass as described above. Moreover, in this case, the position of the end of each inkjet head can be dispersed in the sub-scanning direction by shifting the position in the sub-scanning direction for the plurality of inkjet heads 300a to 300d in the combined head. Thus, for example, the influence of the end in each inkjet head can be prevented from overlapping, and the banding, the streaky spot, and the like can be appropriately prevented from standing out.

When carrying out the printing in the operation of one pass as in the present example, it is usually difficult to carry out the setting of an alternative nozzle, and the like when, for example, the ejection property of any one of nozzle deviates from a normal range. In this case, the influence on the quality of the printing may become large. Thus, when carrying out the printing in the operation of one pass, the variation in the ejection property of each nozzle configuring the same color nozzle row 306 (ejection variation of the nozzle itself) is preferably adjusted to fall within a constant tolerable range set in advance. Furthermore, in the present example, the adjustment of the ejection property (correction of the nozzle variation for every nozzle) is carried out using the ejection spot detecting unit 18 (see FIG. 1), as described above.

More specifically, in such adjustment, a test pattern set in advance such as an ejection spot detection pattern 60 shown in FIG. 1, for example, is printed. Using a pattern including a straight line drawn by the respective nozzles, and the like, for example, for the test pattern is considered. In this case, for example, the ejection amount or the variation in the ejection amount of the nozzle that drew the straight line is detected based on a line width of the straight line. The ejection amount of each nozzle is corrected, as necessary, based on the detected result. Furthermore, in this correction, for example, adjusting an effective voltage of a drive signal for controlling the ejection of the ink by each nozzle, and the like is considered. Moreover, in this case, for example, using a pulse signal of a sawtooth wave form as the drive signal and controlling the pulse width to supply so as to be different for every nozzle, and the like are considered for the adjustment of the effective voltage. For example, consideration is made to preparing a plurality of power supply circuits with different voltage values, and changing the application voltage for every nozzle according to the property of each nozzle. The printing in the operation of one pass, for example, thus can be more appropriately carried out by carrying out such correction of the ejection property.

The correction of the ejection property is not limited to a specific method as described above, and various other methods may be used. Furthermore, consideration is made to carrying out the correction of the ejection property, for example, at the time of shipping inspection of the printing device 10 (see FIG. 1). Furthermore, in the present example, the printing device 10 itself has a function necessary for the correction such as the ejection spot detecting unit 18, and the like. Thus, for example, even when replacing the inkjet head at a location using the printing device 10, when property change by the use of the inkjet head has occurred, and the like, the necessary correction and the like can be carried out as needed.

Therefore, in the present example, the printing in one pass can be appropriately carried out with respect to all the ejection positions in the main scanning direction at the position of each nozzle in the combined head including the complementary set portion. Thus, according to the present example, for example, high speed printing (one pass high speed serial print method, ultra high speed serial print technique) in one pass can be appropriately realized in the serial type configuration of carrying out printing by the main scanning operation. More specifically, in this case, all the nozzles in the combined head are used and the number of main scanning operations carried out with respect to the same position on the medium with the same nozzle is set to one, which is a minimum number, so that higher speed of about 4 to 32 times can be realized compared to, for example, when carrying out printing through the conventional multi-pass method. Furthermore, in this case, the occurrence of banding, and the like can be appropriately suppressed while carrying out the printing in one pass by shifting the positions in the sub-scanning direction of the plurality of inkjet heads in the combined head with respect to each other. Thus, for example, the printing result of higher quality can be obtained, and the high quality printing can be appropriately carried out.

Furthermore, when using the plurality of inkjet heads in the configuration like the combined head of the present example, the width of the head unit 12 in the sub-scanning direction can be greatly reduced compared to, for example, when arranging the plurality of inkjet heads in a conventional stagger method. For example, considering the configuration for realizing the same printing speed, the width (width in the sub-scanning direction) of the head unit 12 in the present example can be reduced to 1/10 or smaller than the case of the stagger method. Thus, according to the present example, for example, the printing device 10 can be miniaturized. In this case, the miniaturization reduces the printing device 10, which leads to the price of the printing device 10 to be reduced, and the like.

Next, an alternative embodiment of the configuration and the operation of the printing device 10 will be described. In the above description, the configuration of the plurality of inkjet heads in the combined head 102 has been described for a case of using mainly four inkjet heads 300a to 300d and arranging the inkjet heads in a line in the main scanning direction with the positions in the sub-scanning direction sequentially shifted by 1.25 times the nozzle interval PL (1.25 PL). However, the number and the arrangement of the inkjet heads in the combined head 102 can be variously changed.

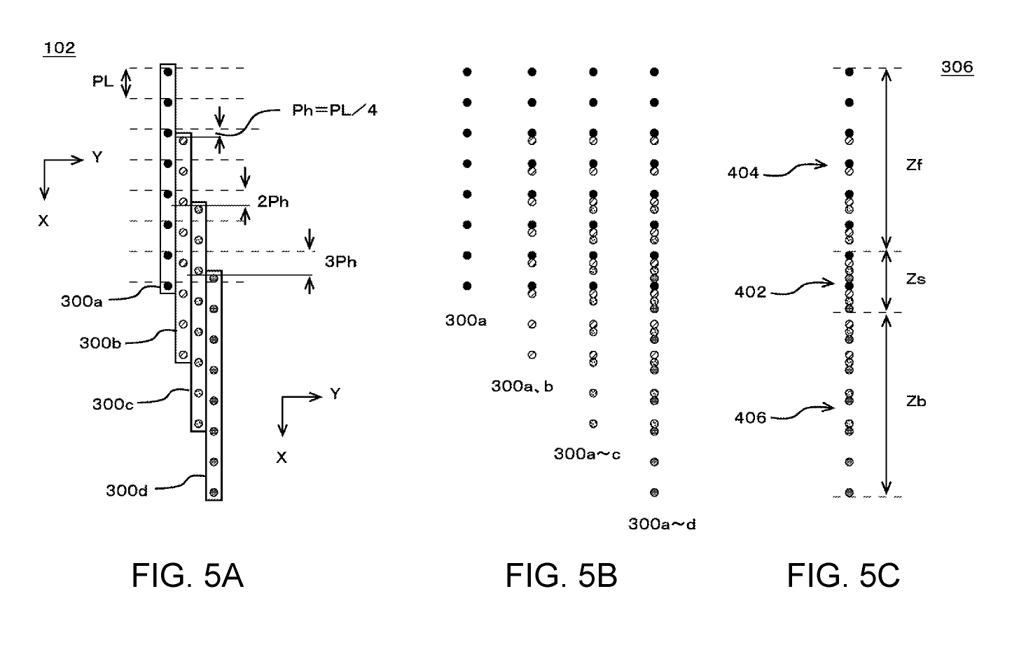

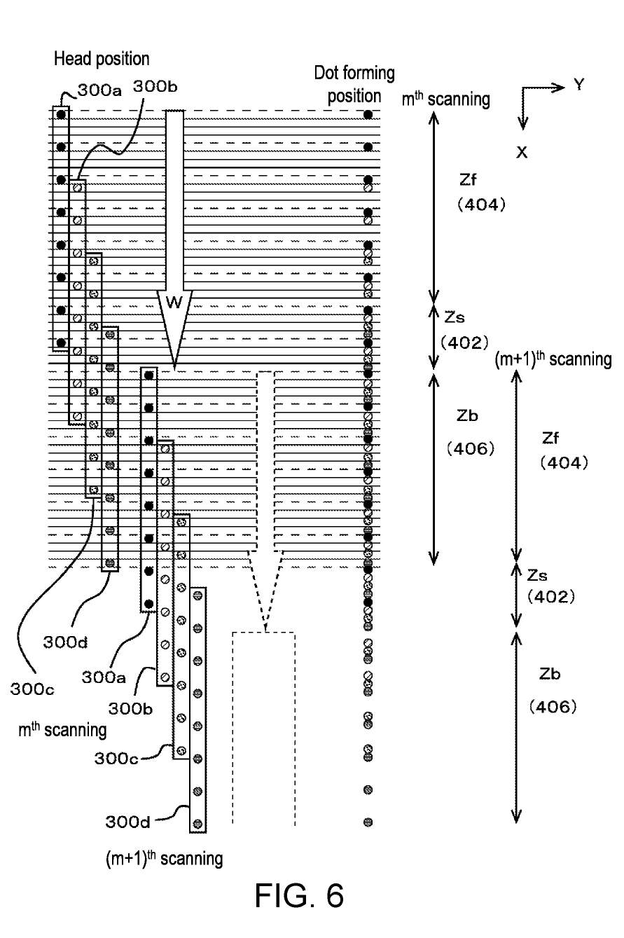

FIGS. 5 and 6 are views describing an alternative embodiment of the configuration of the combined head 102, and show an example of the configuration and the operation of when the shift amount of the position in the sub-scanning direction is changed to 2.25 times the nozzle interval PL (2.25 PL) for a case in which one combined head 102 includes four inkjet heads 300a to 300d. Excluding the points described below, in FIGS. 5 and 6, the configurations denoted with the same reference symbols as FIGS. 1 to 4 may have features same as or similar to the configurations in FIGS. 1 to 4.

FIGS. 5A to 5C are views describing various features of the present alternative embodiment, and show a feature of the present alternative embodiment corresponding to the matter described above using FIGS. 2B, 3A and 3B. FIG. 6 shows the feature of the present alternative embodiment corresponding to the matter described above using FIG. 4. As can be seen from the features, and the like illustrated in FIGS. 5 and 6, high speed printing can be appropriately carried out by carrying out the printing in the operation of one pass in the present alternative embodiment as well. Furthermore, in this case, the banding, the streaky spot, and the like can be appropriately prevented from standing out, and the like by shifting the positions in the sub-scanning direction for the plurality of inkjet heads 300a to 300d in the combined head. Furthermore, in a further alternative embodiment of the configuration of the combined head 102, the shift amount of the positions in the sub-scanning direction with respect to the plurality of inkjet heads 300a to 300d may be set to a distance other than the above. Furthermore, the number of inkjet heads of the combined head 102 can also be variously changed.

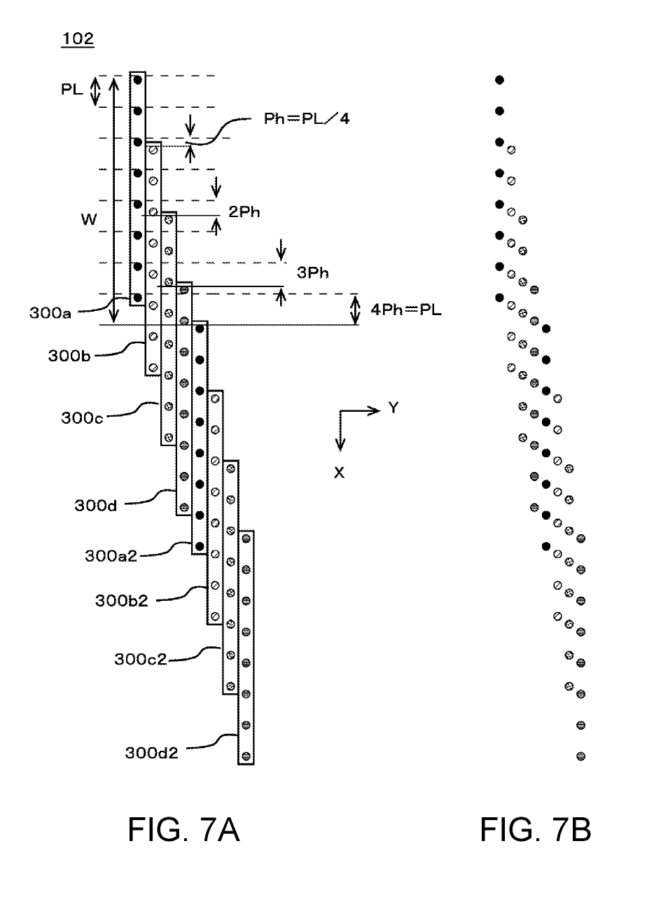

FIGS. 7 to 9 are views describing a further alternative embodiment of the configuration of the combined head 102, and show an example of the configuration and the operation of the combined head 102 for a case in which one combined head 102 includes eight inkjet heads 300a to 300d2. Excluding the points described below, in FIGS. 7 to 9, the configurations denoted with the same reference symbols as FIGS. 1 to 6 may have features same as or similar to the configurations in FIGS. 1 to 6.

FIG. 7A and FIG. 7B are views describing the configuration of the combined head 102 in the present alternative embodiment. FIG. 7A shows an example of an arrangement of a plurality of inkjet heads 300a to 300d2 in the combined head 102. FIG. 7B is a view describing a position of a nozzle in the combined head 102 of the present alternative embodiment. In the present alternative embodiment, the combined head 102 further includes four inkjet heads 300a2 to 300d2 in addition to the four inkjet heads 300a to 300d arranged same as in the case shown in FIG. 5A. Furthermore, the four inkjet heads 300a2 to 300d2 are arranged so that the positions in the sub-scanning direction are shifted by a distance corresponding to the width W of one inkjet head with respect to the four inkjet heads 300a to 300d, as shown in the figure.

In this case, the positions of the nozzles of the combined head 102 of the present alternative embodiment are spread to a wider range in the sub-scanning direction, as schematically shown in FIG. 7B. Furthermore, in this case, the virtual same color nozzle row in the combined head 102 can be considered as being divided to the central region, the one end side region, and the other end side region.

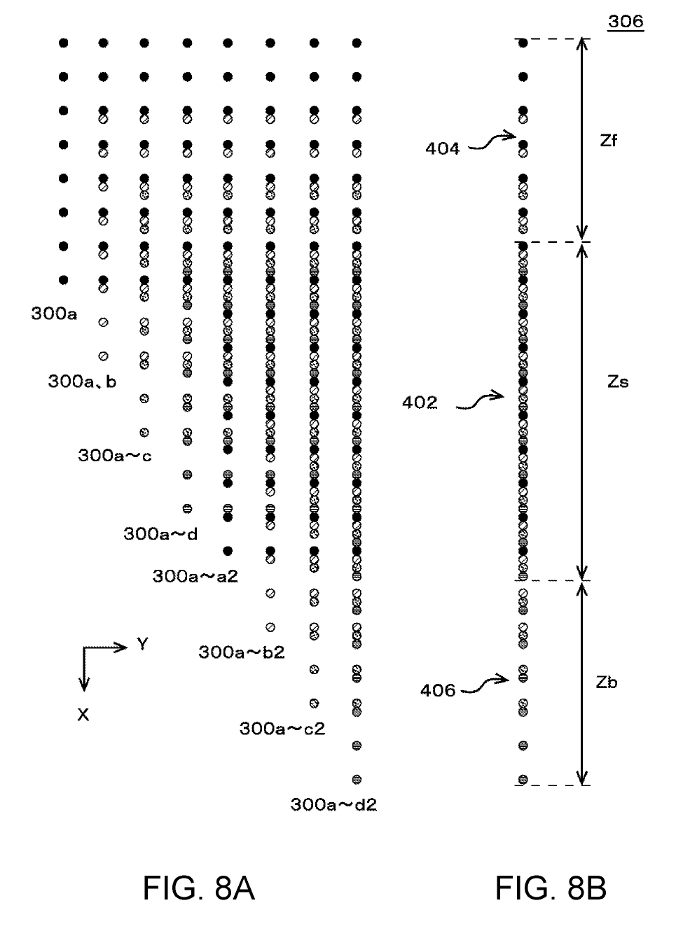

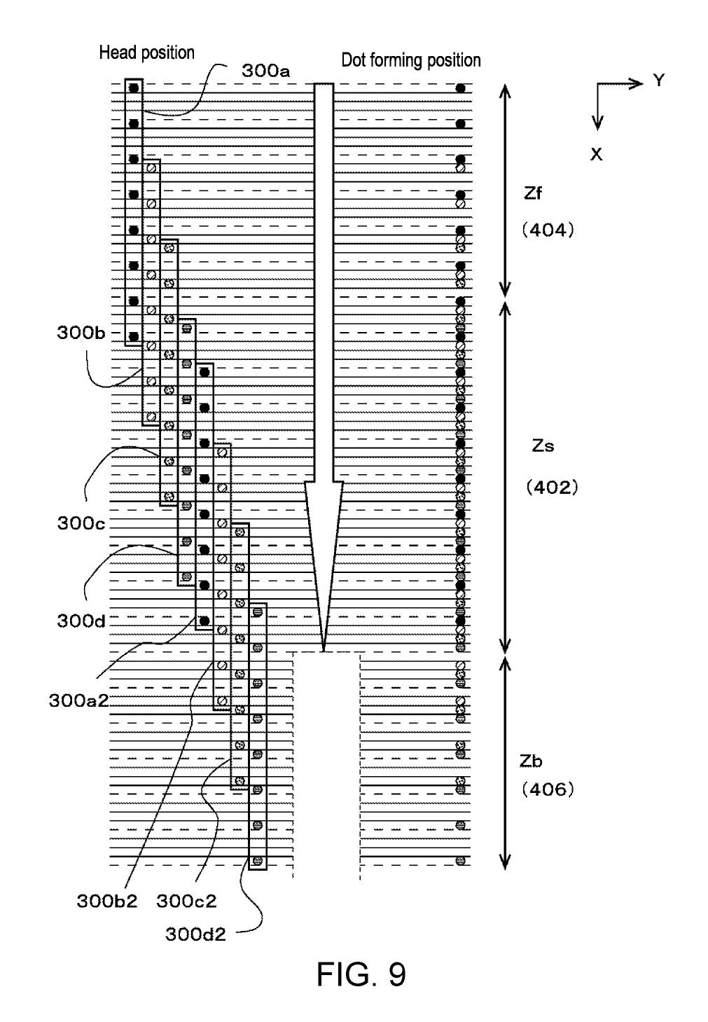

FIGS. 8 and 9 are views describing in further detail the features of the present alternative embodiment. FIGS. 8A and 8B show a feature of the present alternative embodiment corresponding to the matter described above using the right side portion of FIG. 3A and FIG. 3B. FIG. 9 shows a feature of the present alternative embodiment corresponding to one part of the matter described above using FIG. 4. As can be seen from the illustrated feature, and the like, the high speed printing can be appropriately carried out by carrying out the printing in the operation of one pass in the present alternative embodiment as well. Furthermore, in this case, the banding, the streaky spot, and the like can be appropriately prevented from standing out, and the like by shifting the positions in the sub-scanning direction for the plurality of inkjet heads 300a to 300d in the combined head.

Furthermore, as can be seen from the features of the same color nozzle row 306, and the like shown in FIG. 8B, the width of the central region 402 is made longer as the combined head 102 includes the greater number of inkjet heads in the present alternative embodiment. Thus, consideration is made to setting the feeding amount at the time of the sub-scanning operation according to the width of the central region 402, and the like. More specifically, in this case, the feeding amount at the time of the sub-scanning operation becomes twice the width W of one inkjet head. According to the present alternative embodiment, for example, a higher speed printing can be carried out by increasing the feeding amount by one sub-scanning operation.

Next, supplementary description related to each configuration described above, description of a further alternative embodiment, and the like will be made. First, regarding the configuration of the combined head, the number and the arrangement of the inkjet heads will be described in a more generalized manner. As described above, the number and the arrangement of the inkjet heads in the combined head can be variously changed. In this case, the shift amount of the positions in the sub-scanning direction with respect to the plurality of inkjet heads in the combined head can also be variously changed within a range satisfying the complementary set described above.

Considering the features of the plurality of inkjet heads in the combined head in a more generalized manner, the relationship of the nozzle interval PL in the respective inkjet heads and the dot interval Ph can be assumed to be in a relationship of PL=k·Ph (k is a natural number greater than or equal to two). In this case, the combined head is configured with k or more inkjet heads. Furthermore, in this case, assuming the inkjet head, the position of which in the sub-scanning direction is first from one end side is a first head, and the inkjet head, the position of which in the sub-scanning direction is ith (i is a natural number greater than or equal to two and smaller than or equal to k) from the one end side is an ith head of the plurality of inkjet heads in the combined head, the positions in the sub-scanning direction of the first head and the ith head can be assumed as being shifted by αi·PL+βi·Ph (αi is a natural number greater than or equal to one, βi is a natural number greater than or equal to one and smaller than or equal to k−1).

Furthermore, in this case, assuming the inkjet head, the position of which in the sub-scanning direction is jth (j is a natural number greater than or equal to two and smaller than or equal to k, and different from i) from one end side in the combined head, is a jth head, the position in the sub-scanning direction of the jth head can be assumed as being shifted by αj·PL+βj·Ph (αj is a natural number greater than or equal to one, βj is a natural number greater than or equal to one and smaller than or equal to k−1) from the first head. In this case, βj can be assumed to be, for example, a natural number different from βi. Furthermore, αj is preferably a natural number different from αi. Moreover, in this case, αi and αj are preferably smaller than or equal to k.

According to such configuration, for example, the interval in the sub-scanning direction of the dots of the inks that can be formed in one main scanning operation can be made smaller than the nozzle interval PL. Thus, for example, the resolution of printing that can be realized with one print pass can be appropriately enhanced. Furthermore, in this case, the boundary (boundary of print pass) of the region formed with each main scanning operation can be prevented from standing out, as described above, by arranging the inkjet heads in the combined head while shifting the positions in the sub-scanning direction. Thus, according to such configuration, for example, high quality printing can be appropriately carried out at high speed. Furthermore, for example, the printing through the inkjet method can be more appropriately carried out.

Furthermore, in this case, αi, αj, βi, βj can be considered to be set to satisfy for example, αi=(i−1)·A (A is a natural number greater than or equal to one), αj=and βi=i−1, βj=j−1. According to such configuration, for example, the plurality of inkjet heads can be arranged regularly and appropriately. Furthermore, the configuration described above in a generalized manner can be considered as, for example, a configuration of k row arranging the k inkjet heads, in which the nozzles are arranged at the nozzle interval PL corresponding to the low resolution RL, while sequentially shifting k times by α·PL+β·Ph. In this case, α is, for example, a natural number greater than or equal to one and smaller than or equal to k. Furthermore, β is a natural number greater than or equal to one and smaller than or equal to (k−1).

Furthermore, in this case, when the position of the nozzle of each inkjet head is projected in the sub-scanning direction, a plurality of nozzles are arranged at the interval Ph (=PL/k) within a range corresponding to the central region of the same color nozzle row. Thus, the resolution of the nozzle for the entire combined head can be assumed to become k times the resolution of the nozzle of the single inkjet head. More specifically, in this case, if k=4, α=β=1, for example, the configuration of the combined head shown in FIG. 2B and the like is obtained. In this case, if the resolution RL corresponding to the nozzle interval PL is 150 dpi, the resolution of the nozzle in the combined head becomes 600 dpi, which is k times (four times) the resolution RL. Thus, according to such configuration, for example, the combined head of high resolution can be appropriately realized.

The number of parameters described above is not limited specifically, and can be considered to be set variously. Furthermore, in this case, the number k of inkjet heads in one combined head is preferably about greater than or equal to two and smaller than or equal to four in view of the usage number of the inkjet heads becoming too large, the trouble of arraying, and the like. Moreover, the shift amount of the position in the sub-scanning direction is determined according to a value of each parameter for the plurality of inkjet heads of the combined head. In this case, consideration is also made to set the shift amount of the position in view of, for example, visual sensitivity of a human. More specifically, for example, when the shift amount of the position can be increased using the inkjet head in which the width in the sub-scanning direction is sufficiently large, the shift amount of the position is preferably sufficiently larger than a distance corresponding to the peak of the visual sensitivity. In this case, consideration is made to, for example, have the shift amount of the position to greater than or equal to two times, and preferably, greater than or equal to three times the distance corresponding to the peak of the visual sensitivity.

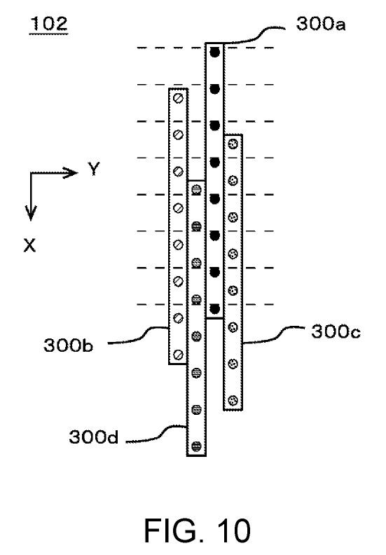

Moreover, regarding the arrangement of the plurality of inkjet heads of the combined head, the position (order), and the like of the inkjet head in the main scanning direction are not particularly limited, and can be variously changed. FIG. 10 shows a further alternative embodiment of the configuration of the combined head 102. Excluding the points described below, in FIG. 10, the configurations denoted with the same reference symbol as FIGS. 1 to 9 may have features same as or similar to the configurations in FIGS. 1 to 9.

In the present alternative embodiment, the combined head 102 has a configuration in which the positions in the main scanning direction of the plurality of inkjet heads 300a to 300d are changed with respect to the combined head 102 shown in FIG. 2B. More specifically, in the present alternative embodiment, the plurality of inkjet heads 300a to 300d are arranged in a line in the main scanning direction so that the positions of the respective ends (positions in the sub-scanning direction) change in a jaggy mariner. Even when configured in such a manner, the printing in the operation of one pass can be appropriately carried out. Furthermore, in this case as well, the banding, the streaky spot, and the like can be appropriately prevented from standing out by shifting the positions in the sub-scanning direction for the plurality of inkjet heads 300a to 300d.

The configuration of when a physically independent one inkjet head includes one nozzle row has been mainly described above. However, considering advancement in higher resolution manufacturing technique and the like, the number (row arrangement) of the nozzle rows in one physical inkjet head may be in plurals, and the like. In this case, for example, the one nozzle row can be considered as the configuration corresponding to a logical inkjet head. Thus, in this case, the physically independent one inkjet head can be considered as the configuration including a plurality of logical inkjet heads, and the like. Furthermore, in this case, consideration can be made to forming all the nozzle rows in the combined head in one physical inkjet head. In this case, the combined head can be considered to have a configuration including a plurality of logical inkjet heads corresponding to the plurality of nozzle rows, and the like. Furthermore, when a physically independent one inkjet head includes a plurality of nozzle rows, the position relationship between the inkjet heads of when a physically independent one inkjet head includes one nozzle row can be considered by replacing it with the position relationship between the nozzle rows.

Furthermore, the configuration and the operation of when carrying out the printing using the instant drying type ink that generates heat by the irradiation of the ultraviolet light has been mainly described above. However, in a further alternative embodiment of the configuration of the printing device 10 (see FIG. 1), consideration can be made to using other various inks. In this case, the ink having high drying speed and the configuration (system) of the printing device 10 are preferably used to appropriately suppress smearing even when the printing in fewer pass number is carried out. More specifically, in this case, consideration can be made to using the instant drying type ink that generates heat according to the energy line other than the ultraviolet light such as the ink that generates heat according to an infrared light.

Furthermore, consideration can be made to using an ultraviolet curable ink (UV) ink that is cured by the irradiation of the ultraviolet light, for example, other than the instant drying type ink. In this case, the ultraviolet light source 104 (see FIG. 1) in the combined head can be considered as being used as the configuration for curing the ink. Even when configured in such a manner, for example, the smearing can be appropriately prevented from occurring by irradiating the ultraviolet light immediately after the landing of the ink. Furthermore, for example, consideration can be made to using a solvent UV ink (SUV) ink, which is an ultraviolet curable ink diluted with a solvent, and the like for the quick drying ink that can suppress smearing. In this case, for example, the ink can be fixed to the medium using a heating means that volatilizes and removes the solvent in the ink by heating the medium, and an ultraviolet light source that cures the ink. Furthermore, using an ink that contains a solvent having a lower boiling point than water, and the like can be considered for the ink that can volatilize and remove the solvent in a short time. In this case, for example, an ink using alcohol for the solvent, and the like can be considered.

Furthermore, the color of the ink is not limited to a specific color as long as the ink of one or more number of colors is used. For example, not limited to the ink of each color of CMYK described above, inks of other colors may be used. In this case, for example, consideration is made to carrying out printing through a seven color separation method using inks of seven colors, each color of red (R), green (G), and blue (B) in addition to each color of CMYK. According to such configuration, for example, the usage amount of the ink can be reduced in total. Furthermore, for example, the smearing thus can be more appropriately suppressed even if the speed of the printing is a higher speed. In this case, consideration is made to arranging the combined head of each color by dividing into a combined head for each color of CMY, which is a primary color, a combined head for each color of RGB, which is a secondary color, and a combined head for K color, which is a tertiary color. More specifically, in this case, the plurality of combined heads for the primary color are arranged in a line in the main scanning direction with the positions in the sub-scanning direction aligned similar to, for example, the case of the head unit 12 shown in FIG. 1. Furthermore, the plurality of combined heads for the secondary color are arranged in a line in the main scanning direction with the positions in the sub-scanning direction aligned so that the positions in the sub-scanning direction do not overlap with the plurality of combined heads for the primary color. The combined head for the tertiary color is arranged so that the position in the sub-scanning direction does not overlap with the plurality of combined heads for the primary color and for the secondary color. According to such configuration, for example, the amount of ink to be ejected to the same position on the medium in the same main scanning operation can be more appropriately reduced. The smearing of the ink thus can be more reliably suppressed, and a more brilliant printing can be carried out. Furthermore, consideration is made to using, for example, ink of a specific color such as white color, pearl color, metallic color, and the like, as well as a clear color for the ink.

Furthermore, the medium to be printed is not limited to a specific medium, and various media that can be printed through the inkjet method can be used. More specifically, for example, consideration is made to using plastic film, fabric, wood, ceramic, glass, metal, paper, and the like for the medium. Furthermore, the configuration of the printing device 10 described above is not limited to a specific intended purpose, and can be applied to various intended purposes. More specifically, the configuration of the printing device 10 can be suitably applied to sign graphics printer, textile printer, and the like. This is not the sole case, and application can be widely made to various industrial printers, application machine of various types of liquid solutions, 3D printer, and the like.

In the above description, the operation of printing has been described mainly for a case of carrying out printing in the operation of one pass. However, the operation of printing may be further modified depending on the intended purpose and the required quality of printing, the state of the printing device 10, or the like. For example, when carrying out the nozzle recovery by an alternative process with respect to the abnormal nozzle, and the like, consideration is also made to carrying out the operation of printing so that the ink can be ejected with a plurality of nozzles with respect to each position on the medium by increasing the pass number of printing.

The present disclosure can be suitably used for, for example, a printing device.

What is claimed is:

1. A printing device that carries out printing through an inkjet method with respect to a medium, the printing device comprising:
a head unit that ejects an ink to the medium; and
a scanning driving unit that causes the head unit to carry out a main scanning operation and a sub-scanning operation, the main scanning operation ejecting the ink while relatively moving with respect to the medium in a main scanning direction set in advance, and the sub-scanning operation relatively moving with respect to the medium in a sub-scanning direction orthogonal to the main scanning direction; wherein
the head unit includes a same color head group configured by a plurality of inkjet heads that eject an ink of a same color,
each of the plurality of inkjet heads in the same color head group includes a nozzle row in which a plurality of nozzles are arranged in a predetermined nozzle row direction at a constant nozzle interval PL and arranged with positions in the sub-scanning direction shifted from each other,
the nozzle interval PL has a relationship of PL=k·Ph (k is a natural number greater than or equal to two) with respect to a dot interval Ph in the sub-scanning direction corresponding to a resolution of printing carried out with respect to the medium, the same color head group configured by k or more inkjet heads, and
positions in the sub-scanning direction of a first head and an ith (i is a natural number greater than or equal to two and smaller than or equal to k) head are shifted by αi·PL+βi·Ph (αi is a natural number greater than or equal to one, βi is a natural number greater than or equal to one and smaller than or equal to k−1), the first head being the inkjet head, the position of which in the sub-scanning direction is first from one end side in the sub-scanning direction of the plurality of inkjet heads in the same color head group, and the ith head being the inkjet head, the position of which in the sub-scanning direction is ith from the one end side.

2. The printing device according to claim 1, wherein the scanning driving unit causes the head unit to carry out the main scanning operation and the sub-scanning operation so that each of the inkjet heads in the same color head group carries out only one main scanning operation with respect to each position of the medium.

3. The printing device according to claim 1, wherein a position in the sub-scanning direction of a jth (j is a natural number greater than or equal to two and smaller than or equal to k, and different from i) head, which is the inkjet head, the position of which in the sub-scanning direction is jth from the one end side in the sub-scanning direction of the plurality of inkjet heads in the same color head group is shifted by αj·PL+βj·Ph (αj is a natural number greater than or equal to one, βj is a natural number greater than or equal to one and smaller than or equal to k−1) from the first head, βj being a natural number different from βi.

4. The printing device according to claim 3, wherein αj is a natural number different from αi.

5. The printing device according to claim 3, wherein αi=(i−1)·A (A is a natural number greater than or equal to one), αj=(j−1)·A, and
βi=i−1, and βj=j−1.

6. The printing device according to claim 1, wherein when an arrangement of the plurality of nozzles in each of all the inkjet heads in the same color head group is defined as a same color nozzle row, a density at which the nozzles are arranged in the sub-scanning direction is defined as a nozzle density, and the nozzle density of when an interval in the sub-scanning direction is equal to the dot interval Ph is defined as a resolution corresponding density;
the same color nozzle row includes
a one-end side region, which is a region on one end side in the sub-scanning direction, in which the nozzle density is smaller than the resolution corresponding density,
an other end side region, which is a region on the other end side in the sub-scanning direction, in which the nozzle density is smaller than the resolution corresponding density, and
a central region, which is a region between the one end side region and the other end side region, in which the nozzle density is equal to the resolution corresponding density, and
in the sub-scanning operation carried out between two successive main scanning operations, the scanning driving unit moves the plurality of inkjet heads in the same color head group in the sub-scanning direction by a feeding amount equal to a length in the sub-scanning direction of a range combining the one end side region and the central region with respect to the medium.

7. The printing device according to claim 6, wherein with respect to a region where the nozzle included in one of the one end side region or the other end side region in the same color nozzle row ejects the ink in any one of the main scanning operation, the nozzle included in the other one of the one end side region or the other end side region ejects the ink in a next one of the main scanning operation, and
a relationship of a position of the nozzle included in the one end side region and a position of the nozzle included in the other end side region is in a complementary relationship such that with respect to a position where the nozzle included in one of the one end side region or the other end side region cannot eject the ink in any one of the main scanning operation as the nozzle density is smaller than the resolution corresponding density, the nozzle included in the other one of the one end side region or the other end side region ejects the ink in the next one of the main scanning operation.

8. The printing device according to claim 1, wherein the head unit includes a plurality of same color head groups respectively ejecting an ink of a color different from each other.

9. The printing device according to claim 1, wherein
an ink that generates heat by irradiation of an energy line is used for the ink,
the head unit further includes an energy line irradiating unit that irradiates an ink attached to the medium with the energy line, and
the energy line irradiating unit irradiates the ink with the energy line to volatilize and remove at least one part of a solvent in the ink.

10. The printing device according to claim 1, wherein an ultraviolet curable ink that is cured by irradiation of an ultraviolet light is used for the ink, and
the head unit further includes an ultraviolet light source that irradiates the ink attached to the medium with an ultraviolet light.

11. A printing method that carries out printing through an inkjet method with respect to a medium, the method comprising the steps of
causing a head unit that ejects an ink to the medium to carry out
a main scanning operation and a sub-scanning operation, the main scanning operation ejecting the ink while relatively moving with respect to the medium in a main scanning direction set in advance, and the sub-scanning operation relatively moving with respect to the medium in a sub-scanning direction orthogonal to the main scanning direction, wherein
the head unit includes a same color head group configured by a plurality of inkjet heads that eject an ink of a same color,
each of the plurality of inkjet heads in the same color head group includes a nozzle row in which a plurality of nozzles are arranged in a predetermined nozzle row direction at a constant nozzle interval PL and arranged with positions in the sub-scanning direction shifted from each other,
the nozzle interval PL has a relationship of PL=k·Ph (k is a natural number greater than or equal to two) with respect to a dot interval Ph in the sub-scanning direction corresponding to a resolution of printing carried out with respect to the medium, the same color head group configured by k or more inkjet heads, and
a position in the sub-scanning direction of a first head and an ith (i is a natural number greater than or equal to two and smaller than or equal to k) head is shifted by αi·PL+βi·Ph (αi is a natural number greater than or equal to one, βi is a natural number greater than or equal to one and smaller than or equal to k−1), the first head being the inkjet head, the position of which in the sub-scanning direction is first from one end side in the sub-scanning direction of the plurality of inkjet heads in the same color head group, and the ith head being the inkjet head, the position of which in the sub-scanning direction is ith from the one end side.

12. A printing device that carries out printing through an inkjet method with respect to a medium, the printing device comprising:
a head unit that ejects an ink to the medium; and
a scanning driving unit that causes the head unit to carry out a main scanning operation and a sub-scanning operation, the main scanning operation ejecting the ink while relatively moving with respect to the medium in a main scanning direction set in advance, and the sub-scanning operation relatively moving with respect to the medium in a sub-scanning direction orthogonal to the main scanning direction, wherein
the head unit includes a plurality of nozzle rows that eject an ink of a same color,
each of the plurality of nozzle rows is a nozzle row in which a plurality of nozzles are arranged in a predetermined nozzle row direction at a constant nozzle interval PL and the plurality of nozzle rows are arranged with positions in the sub-scanning direction shifted from each other,
the nozzle interval PL has a relationship of PL=k·Ph (k is a natural number greater than or equal to two) with respect to a dot interval Ph in the sub-scanning direction corresponding to a resolution of printing carried out with respect to the medium, the head unit including k or more nozzle rows, and
positions of a first nozzle row and an ith (i is a natural number greater than or equal to two, and smaller than or equal to k) nozzle row are shifted by αi·PL+βi·Ph (αi is a natural number greater than or equal to one, βi is a natural number greater than or equal to one and smaller than or equal to k−1), the first nozzle being the nozzle row which position in the sub-scanning direction is first from one end side in the sub-scanning direction of the plurality of nozzle rows, and the ith nozzle row being the nozzle row which position in the sub-scanning direction is ith from the one end side.

13. A printing method that carries out printing through an inkjet method with respect to a medium, the method comprising the steps of:
causing a head unit that ejects an ink to the medium to carry out
a main scanning operation and a sub-scanning operation, the main scanning operation ejecting the ink while relatively moving with respect to the medium in a main scanning direction set in advance, and the sub-scanning operation relatively moving with respect to the medium in a sub-scanning direction orthogonal to the main scanning direction, wherein
the head unit includes a plurality of nozzle rows that eject an ink of a same color,
each of the plurality of nozzle rows is a nozzle row in which a plurality of nozzles are arranged in a predetermined nozzle row direction at a constant nozzle interval PL and the plurality of nozzle rows are arranged with positions in the sub-scanning direction shifted from each other,
the nozzle interval PL has a relationship of PL=k·Ph (k is a natural number greater than or equal to two) with respect to a dot interval Ph in the sub-scanning direction corresponding to a resolution of printing carried out with respect to the medium, the head unit including k or more nozzle rows, and
positions of a first nozzle row and an ith (i is a natural number greater than or equal to two, and smaller than or equal to k) nozzle row are shifted by αi·PL+βi·Ph (αi is a natural number greater than or equal to one, βi is a natural number greater than or equal to one and smaller than or equal to k−1), the first nozzle being the nozzle row which position in the sub-scanning direction is first from one end side in the sub-scanning direction of the plurality of nozzle rows, and the ith nozzle row being the nozzle row which position in the sub-scanning direction is ith from the one end side.
